(19) United States
(12) Patent Application Publication
(10) Pub. No.: US 2026/0043454 A1
(43) Pub. Date: Feb. 12, 2026

(54) VIBRATION DAMPER FOR A MOTOR VEHICLE

(71) Applicants: thyssenkrupp Bilstein GmbH, Ennepetal (DE); thyssenkrupp AG, Essen (DE)

(72) Inventor: Lars SCHWEDLER, Arnsberg (DE)

(73) Assignees: thyssenkrupp Bilstein GmbH, Ennepetal (DE); thyssenkrupp AG, Essen (DE)

(21) Appl. No.: 19/293,227

(22) Filed: Aug. 7, 2025

(30) Foreign Application Priority Data
Aug. 12, 2024 (DE) 10 2024 122 901.2

(51) Int. Cl. F16F 9/49; B60G 13/08; B60G 17/08

(52) U.S. Cl. CPC F16F 9/49; B60G 13/08; B60G 17/08; B60G 2202/24; B60G 2204/62; B60G 2206/41; B60G 2500/104; B60G 2600/21; B60G 2800/162; B60G 2800/916; F16F 2222/12; F16F 2228/066; F16F 2230/42; F16F 2232/08; F16F 2234/02

(57) ABSTRACT

A vibration damper for a vehicle comprises a damper tube filled with hydraulic fluid, a working piston, which is connected to a piston rod and is arranged movably back and forth within the damper tube, the interior of the damper tube being divided by the working piston into a first working chamber on the piston rod side and a second working chamber away from the piston rod, an auxiliary piston, which is mounted on the piston rod, and a compression stop assembly with a compression stop receptacle mounted inside the damper tube, for receiving the auxiliary piston in the compression stage, wherein the compression stop receptacle comprises a sleeve-shaped region with a constant diameter and has at least one expansion protruding radially from the sleeve-shaped region.

### CROSS REFERENCE TO RELATED APPLICATION

This application is a U.S. Non-Provisional that claims priority to German Patent Application No. DE 10 2024 122 901.2, filed Aug. 12, 2024, the entire content of which is incorporated herein by reference.

### FIELD

The present disclosure relates to a vibration damper for a motor vehicle with a compression stop assembly.

### BACKGROUND

A hydraulic vibration damper with a hydraulic compression stop is known from DE 10 2015 121 140 A1. A hydraulic compression stop is usually used to provide additional damping in the compression stage of the vibration damper. For this purpose, in known vibration dampers an auxiliary piston enters a compression stop chamber and thus generates additional damping when the piston rod moves in the compression direction. The components that interact in the compression damping process usually have to comply with very precise production tolerances, for example to compensate for lateral forces on the piston rod. The production of these components is therefore usually very costly. Furthermore, the installation space for a compression stop inside the vibration damper is limited.

Thus a need exists to provide a vibration damper with a compression stop assembly which can be produced at low cost and easily fitted.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a detail of a vibration damper according to an exemplary embodiment, in a longitudinal sectional view.

FIG. 2 shows a schematic illustration of a compression stop receptacle according to an exemplary embodiment, in a longitudinal sectional view.

FIG. 3 shows a schematic illustration of a compression stop receptacle according to an exemplary embodiment, in a further longitudinal sectional view.

FIG. 4 shows a schematic illustration of a compression stop receptacle according to an exemplary embodiment, in a perspective view.

FIG. 5 shows a schematic illustration of a detail of a vibration damper according to a further exemplary embodiment, in a longitudinal sectional view.

FIG. 6 shows a schematic illustration of a detailed view of the vibration damper of FIG. 5 according to a further exemplary embodiment.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

A vibration damper for a vehicle comprises, according to a first aspect, a damper tube filled with hydraulic fluid, a working piston, which is connected to a piston rod and is arranged movably back and forth inside the damper tube, the interior of the damper tube being divided by the working piston into a first working chamber on the piston rod side and a second working chamber away from the piston rod. The vibration damper preferably also comprises a closure package, which creates a fluid-tight seal for the damper tube on the piston rod side. Furthermore, the vibration damper comprises an auxiliary piston, which is mounted on the piston rod, and a compression stop assembly having a compression stop receptacle mounted within the damper tube, for receiving the auxiliary piston in the compression stage, wherein the compression stop receptacle comprises a sleeve-shaped region with a constant diameter, preferably inside diameter, and has at least has one expansion protruding radially from the sleeve-shaped region. Such a sleeve-shaped region of constant diameter permits simple production of the compression stop receptacle. In particular, the compression stop receptacle is produced by cold extrusion. Thus, no machining is necessary, which makes production of the compression stop receptacle significantly more cost-effective. Preferably, the compression stop receptacle is made of a steel, such as DD13.

The vibration damper is, for example, a single-tube or multi-tube vibration damper. For example, a multi-tube vibration damper for a vehicle comprises an outer tube and an inner tube arranged coaxially in relation to the outer tube, with a compensation chamber for receiving hydraulic fluid being formed between the outer tube and the inner tube, and comprises a working piston, which is connected to a piston rod and is arranged movably back and forth inside the inner tube, the interior of the inner tube being divided by the working piston into a first working chamber on the piston rod side and a second working chamber away from the piston rod. The compensation chamber is preferably at least partially filled with a gas, in particular at the upper end. The outer tube preferably forms at least partially the housing of the vibration damper. The inner surface of the inner tube is preferably formed as a guide of the working piston. The working piston preferably has a valve device by which the first and the second working chamber are connected to each other. In the case of a single-tube vibration damper, an outer tube is preferably not provided. The inner tube is referred to as the damper tube and, as described above with respect to the inner tube, receives the piston rod and the working piston.

In the case of a multi-tube vibration damper, the vibration damper has in particular a closure package which is designed and arranged to seal off the interior of the outer tube fluidically on the piston rod side. The end of the inner tube on the piston rod side is preferably fastened to the closure package. Opposite from the closure package, at the end away from the piston rod, the compensation chamber and the second working chamber are preferably fluidically sealed off by means of a bottom piece. The compensation chamber is preferably fluidically connected to the first or second working chamber by way of openings in the inner tube. For example, the compensation chamber is sealed in relation to the inner tube by means of a bottom element. A base valve, which is mounted in particular at the end of the inner tube away from the piston rod, is mounted in particular on the bottom piece. The second working chamber is preferably fluidically connected to the compensation chamber via the base valve. The base valve is preferably a check valve through which flow can pass in both directions or only in one direction. For example, the base valve is designed as a check valve in the rebound direction, in the case of a piston movement in a direction out of the inner tube, and is designed as a characteristic-defining valve in the compression direction, in the case of a piston movement into the inner tube.

In the case of a single-tube vibration damper, the vibration damper has in particular a closure package which is designed and arranged to seal off the interior of the damper tube fluidically on the piston rod side. The end of the damper tube on the piston rod side is preferably fastened to the closure package. The closure package is preferably arranged coaxially in relation to the piston rod and encloses the latter circumferentially. Opposite from the closure package, at the end away from the piston rod, the interior of the damper tube is preferably fluidically sealed off by means of an axially movable sealing element. The sealing element preferably separates a gas chamber, adjoining it in the axial direction, from the working chamber filled with hydraulic fluid.

In the following description, the term vibration damper should be understood as meaning both a multi-tube vibration damper and a single-tube vibration damper, the damper tube being the inner tube of a multi-tube vibration damper.

The compression stop assembly is preferably arranged within the damper tube, in particular in the end region of the damper tube away from the piston rod, and preferably comprises the compression stop receptacle.

The auxiliary piston preferably comprises a piston ring which is mounted axially movably inside the auxiliary piston and, with its outer circumferential surface, preferably bears in a fluid-tight manner at least partially or completely against the inner wall of the compression stop receptacle. The piston ring is preferably not fastened to the piston rod and the auxiliary piston. The piston ring and the piston rod are in particular mounted so as to be movable relative to each other. The compression stop assembly also comprises a compression stage working chamber, which is separated by the piston ring inside the damper tube, in particular the compression stop receptacle. The auxiliary piston is fastened to the piston rod in a fixed position and arranged in the compression direction relative to the working piston. The piston ring is, for example, circular, cylindrical or in particular C-shaped and has, for example, a passage opening formed as a slit, which represents a complete circumferential interruption of the annular piston ring.

The compression stop assembly preferably has a compression stage working chamber, which is separated by the piston ring within the compression stop receptacle, and wherein the interruption or passage opening at least partially or completely forms a bypass channel between the compression stage working chamber and the working chamber away from the piston rod. The compression stage working chamber is preferably formed between the piston ring and the bottom of the in particular hollow-cylindrical compression stop receptacle. The bypass channel is preferably formed by the interruption or passage opening in the piston ring and the space between the outer diameter of the auxiliary piston and the inner diameter of the compression stop receptacle.

In the following, a movement in the rebound direction is understood as a movement in the direction of the closure package into the region of the shock absorber on the piston rod side, and a movement in the compression direction is understood as a movement in the direction of the base valve into the region of the shock absorber away from the piston rod.

In the compression stage, the piston rod is moved in the compression direction, so that the piston ring is moved in the compression direction within the compression stop stage receptacle. The bypass channel permits a flow of hydraulic fluid out of the compression stage working chamber, upon movement of the piston ring in the compression direction, and thus generates the damping of the piston rod movement in the compression direction.

According to a first embodiment, the expansion extends from the piston rod end of the compression stop receptacle in the axial direction, in particular in the compression direction.

Preferably, the expansion extends to the end face of the compression stop receptacle. The expansion preferably forms a bypass path, which extends from the end face of the compression stop receptacle between the wall of the compression stop receptacle and the auxiliary piston. The bypass path allows a fluid to flow from the compression stage working chamber into the working chamber away from the piston rod.

According to a further embodiment, the sleeve-shaped region has a constant diameter over the complete axial extent of the compression stop receptacle, with the exception of the at least one expansion. Such a compression stop receptacle is particularly easy to produce. Preferably, the compression stop receptacle consists of the sleeve-shaped region, which has at least one expansion and a bottom. The compression stop receptacle is designed in particular in one piece or as one part.

According to a further embodiment, the compression stop receptacle has a plurality of expansions, which are spaced uniformly from one another in the circumferential direction. For example, the compression stop receptacle has at least two, three, four or five expansions.

According to a further embodiment, the expansion has a first region, which is arranged at the piston rod end of the compression stop receptacle and has a constant diameter over the axial extent of the first region. The diameter of the first region of the expansion of the compression stop receptacle is preferably greater than the diameter of the sleeve-shaped region of the compression stop receptacle. The first region preferably forms the piston rod end of the expansion.

According to a further embodiment, the compression stop receptacle is mounted at the first region on the damper tube. Preferably, by means of the first region, the compression stop receptacle is fastened to the damper tube via a non-positive, positive or material connection. In particular, the compression stop receptacle is mounted on the damper tube only at the first region. Preferably, the compression stop receptacle is welded to the inner tube.

According to a further embodiment, the first region has a constant circumferential width over the axial extent. The circumferential width is to be understood as the extent in the circumferential direction, in particular a partial circle section.

According to a further embodiment, the expansion has a second region, which directly adjoins the first region in the axial direction and has a diameter that changes over the axial extent of the second region. Preferably, the diameter of the second region is reduced or increased in the axial direction. A diameter that changes causes a change in the bypass path and thus in the damping in the compression stage. Preferably, the diameter decreases in the compression direction. Optionally, the diameter of the second region is constant.

According to a further embodiment, the diameter of the second region decreases constantly in the axial direction, in particular in the compression direction. A step-by-step change is also conceivable. A decrease in the compression direction causes progressive damping in the compression stage.

According to a further embodiment, the second region has a circumferential width that changes over the axial extent. According to a further embodiment, the circumferential width of the second region decreases preferably constantly in the compression direction. This likewise provides for progressive damping of the movement of the auxiliary piston in the compression stage.

According to a further embodiment, the compression stop receptacle has a plurality of expansions, all of which are identical.

According to a further embodiment, the expansion extends over about half the axial extent of the compression stop receptacle. This achieves progressive damping of the piston movement up to about half the depth of entry of the piston into the compression stop receptacle. Preferably, the expansions are arranged exclusively in the piston rod half of the compression stop receptacle.

According to a further embodiment, the compression stop receptacle has a wall, which has no bores or passages through which hydraulic fluid is able to flow through the wall in the radial direction.

Between the compression stop receptacle and the damper tube, for example, an annular chamber is formed through which the hydraulic fluid is able to flow. The annular chamber preferably forms a fluid connection between the working chamber remote from the piston rod and the base valve, with the compression stop receptacle being bypassed. In normal operation, where the auxiliary piston is not in the compression stop receptacle, the compression stop receptacle thus does not constitute an obstacle to flow and has a negligible effect on the behaviour of the vibration damper. Even in the operating state in which the auxiliary piston is within the compression stop receptacle, the compression stop receptacle does not constitute an obstacle to flow, and therefore a flow to the base valve is possible.

The compression stop receptacle is preferably designed in the shape of a hollow cylinder. The piston ring is formed in particular from a plastics material. Preferably, the piston ring is produced by means of plastic injection moulding. Forming the piston ring from a plastics material permits cost-effective production of the piston ring.

The auxiliary piston preferably comprises a valve body with at least one or a plurality of axial passage bores, which are at least partially or completely covered by valve discs on the piston rod side. The valve discs are preferably preloaded in such a way that, as from a certain pressure in the compression stage working chamber, they allow a flow from the compression stage working chamber into the second working chamber through the passage bores. The passage bores together with the valve discs thus prevent a pressure increase in the compression stage working chamber that exceeds a certain value. The bypass channel is provided in addition to the passage bores and offers an additional flow channel when the auxiliary piston moves in the compression direction. The bypass channel is formed in particular between the valve body and the compression stop receptacle, and also by the interruption of the piston ring.

The valve body and the valve discs are preferably connected by a connecting element, such as a screw element or a rivet, by way of example to a washer. The piston ring is preferably arranged around the valve body in such a way that it is axially movable, in particular infinitely variably, from a first position, in which it lies against a shoulder of the valve body, into a second position, in which it lies against a disc mounted on the end face of the valve body. The valve body optionally has, on its outer surface, recesses which are preferably arranged in line with cutouts in the disc, so that a bypass channel is formed between the compression stage working chamber and the working chamber away from the piston rod. Optionally, the valve body has no recess, so that the bypass channel is formed exclusively through the passage opening in the piston ring.

When the piston rod moves in the compression direction, the auxiliary piston is moved into the compression stop receptacle. When the auxiliary piston moves in the compression direction, the piston ring lies against the shoulder of the valve body and at least partially closes the bypass channel. When the auxiliary piston moves in the rebound direction, the piston ring lies against the disc and preferably frees the bypass channel. The piston ring preferably serves as a throttle element for restricting the flow cross section of the bypass channel.

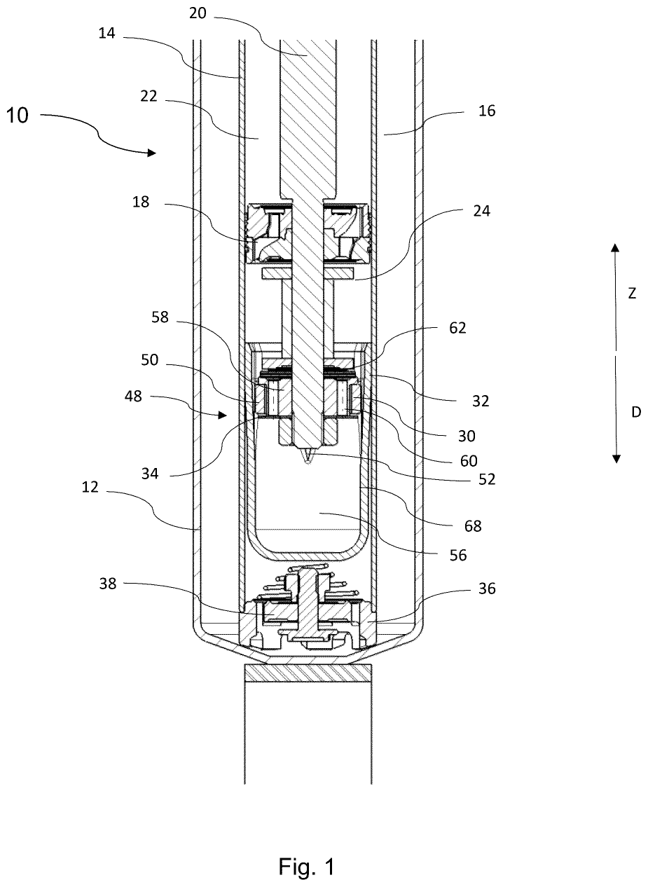

FIG. 1 shows a vibration damper 10, the vibration damper 10 being, by way of example, a multi-tube vibration damper, for example a two-tube vibration damper. The vibration damper 10 has an outer tube 12, which forms an outer surface, in particular a housing, of the vibration damper 10. A damper tube 14, also referred to as inner tube 14, is arranged inside the outer tube 12, coaxially in relation thereto. Formed between the outer tube 12 and the inner tube 14 is a compensation chamber 16, which is preferably at least partially or completely filled with a hydraulic fluid. For example, the compensation chamber 16 is partially filled with a gas.

Inside the inner tube 14, a working piston 18 connected to a piston rod 20 is arranged in such a way that it is movable within the inner tube 14, wherein the inner tube 14 is preferably designed as a guide of the working piston 18. The working piston 18 preferably has a valve device. For example, the valve device comprises a rebound stage valve, for damping the piston movement in the rebound stage, and a compression stage valve, for damping the piston movement in the compression stage. Preferably, the valves are each formed by a passage opening through the piston and a valve disc pack. The working piston 18 divides the interior of the inner tube 14 into a first working chamber 22, which is arranged on the piston rod side, and a second working chamber 24, which is arranged away from the piston rod. The piston rod 20 can preferably be connected to the vehicle body with its end protruding from the damper tube 14. The working piston 18 is fastened to the piston rod preferably in a fixed position. The vibration damper 10 comprises an auxiliary piston 50 which is likewise mounted on the piston rod 20 in a fixed position, wherein the auxiliary piston 50 is mounted on a region of the piston rod 20 adjacent to the working piston in the compression direction D. Preferably, the auxiliary piston 50 is mounted on the end of the piston rod 20 arranged within the damper tube 14. Between the working piston 18 and the auxiliary piston 50, an in particular sleeve-shaped reinforcement is attached which is mounted around the piston rod 20, coaxially thereto, and fastened to the piston rod 20.

The interior of the outer tube 12 is preferably fluidically sealed off on the piston rod side by means of a closure package (not shown). Opposite from the closure package, at the end away from the piston rod, the compensation chamber 16 is preferably fluidically sealed off by means of a bottom piece 36. The interior of the damper tube 14, in particular the second working chamber 24, is preferably also fluidically sealed off by means of the bottom piece 36. It is also conceivable that a further bottom element is provided separately from the bottom piece, which seals off the outer tube 12. By way of example, a base valve 38, which is mounted in particular on the end of the inner tube 14 away from the piston rod, is arranged on the bottom piece 36. The base valve 38 is preferably a check valve through which a flow can pass in both directions or only in one direction. The second working chamber 24 is preferably fluidically connected to the compensation chamber 16 by way of the base valve 38. The end of the inner tube 14 on the piston rod side is preferably fastened to the closure package.

The outer tube 12 is preferably cylindrical and optionally has a smaller diameter at the end region on the piston rod side. The outer tube 12 is, for example, fluidically sealed off with respect to the piston rod 20 via a seal mounted on that end of the outer tube 14 on the piston rod side.

The vibration damper 10 comprises, by way of example, a compression stop assembly 48, which is arranged inside the damper tube 14, in particular in the end region of the damper tube 14 away from the piston rod. The compression stop assembly 48 preferably comprises a compression stop receptacle 68, which is arranged within the inner tube 14 and is substantially in the shape of a hollow cylinder. Preferably, the compression stop receptacle 68 lies at least partially against the inner surface of the inner tube 14.

The auxiliary piston 50 comprises, for example, a piston ring 30 which is mounted axially movably inside the auxiliary piston 50 and, with its outer circumferential surface, preferably lies in a fluid-tight manner at least partially or completely against the inner wall of the compression stop receptacle 68. Preferably, the piston ring 30 is mounted axially movably inside the auxiliary piston 50 in such a way that the compression stop receptacle 68 forms a guide of the piston ring 30. The piston ring 30 in particular separates off a compression stage working chamber 56 within the compression stop receptacle 68. The compression stage working chamber 56 is preferably arranged completely within the compression stop receptacle 68 behind the piston ring 30 in the compression direction D. Preferably, the compression stop receptacle 68 lies with its outer diameter partially against the inner wall of the damper tube 14.

For example, at its end region facing in the direction of the working piston 18, the compression stop receptacle 68 has a connecting region 32, which is connected, preferably in a fixed position, to the inner tube 14. In particular, the connecting region 32 of the compression stop receptacle 68 has a larger outer diameter than the remaining region of the compression stop receptacle 68 extending in particular from the connecting region in the compression direction D. Outside the connecting region, the compression stop receptacle 68 preferably has an outer diameter which is smaller than the inner diameter of the damper tube 14, so that the hydraulic fluid is able to flow between the damper tube 14 and the compression stop receptacle 68. The compression stop receptacle 68 is preferably connected to the inner tube 14 positively, materially and/or non-positively.

The auxiliary piston 50 comprises a valve body 58 with at least one or a plurality of axial passage bores 60, which are covered by valve discs 62. The valve discs 62 are mounted on the piston rod end of the valve body 58 and preloaded in such a way that, as from a certain pressure in the compression stage working chamber 56, they allow a flow from the compression stage working chamber 56 into the second working chamber 24 through the passage bores 60. The passage bores 60, together with the valve discs 62, thus prevent a pressure increase in the compression stage working chamber 56 that exceeds a certain value.

The piston ring 30 is, for example, arranged circumferentially around the valve body 58 and in particular is axially movable. The piston ring 30 is, for example, circular, cylindrical or in particular C-shaped and has, for example, a passage opening formed as a slit, which represents a complete circumferential interruption of the annular piston ring 30. Preferably, the piston ring has a plurality of passage openings, which are formed in particular as recesses in the inner wall and/or in the end face of the piston ring 30 on the piston rod side. At its end on the piston rod side, for example, the valve body 58 has a radially outwardly facing shoulder, which forms an axial contact surface for the piston ring 30. The piston ring 30 is preferably formed in such a way that it creates a fluid-tight seal with the inner wall of the damper tube 14. The piston ring 30 has, by way of example, a passage opening through which hydraulic fluid is able to flow. The auxiliary piston 50 preferably has a disc 34, which is arranged at the end of the auxiliary piston 50, in particular of the valve body 58, away from the piston rod. The disc 34 preferably protrudes radially beyond the valve body 58 and forms an axial contact surface for the piston ring 30. The valve body 58, the valve discs 62 and the disc 34 are preferably connected by way of a connecting element, such as a screw or a rivet, by way of example to a washer.

The piston ring 30 is preferably arranged around the valve body 58 in such a way that it is axially movable, in particular infinitely variably, from a first position, in which it lies against the shoulder of the valve body 58, into a second position, in which it lies against the disc 34. The valve body 58 optionally has, on its outer surface, recesses which are preferably arranged in line with cutouts in the disc 34, so that a bypass channel is formed between the compression stage working chamber 56 and the working chamber 24 away from the piston rod. Optionally, the valve body 58 has no recess, so that the bypass channel is formed exclusively by the passage opening in the piston ring 30.

In the operation of the shock absorber 10, and when the piston rod 20 moves in the compression direction D, the auxiliary piston 50 is moved into the compression stop receptacle 68, in particular in the compression direction D in the direction of the bottom of the compression stop receptacle 68. When the auxiliary piston 50 moves in the compression direction D, the piston ring 30 lies against the shoulder of the valve body 58 and at least partially closes the bypass channel. When the auxiliary piston 50 moves in the rebound direction Z, the piston ring 30 lies against the disc 34 and preferably frees the bypass channel. The piston ring 30 preferably serves as a throttle element for restricting the flow cross section of the bypass channel.

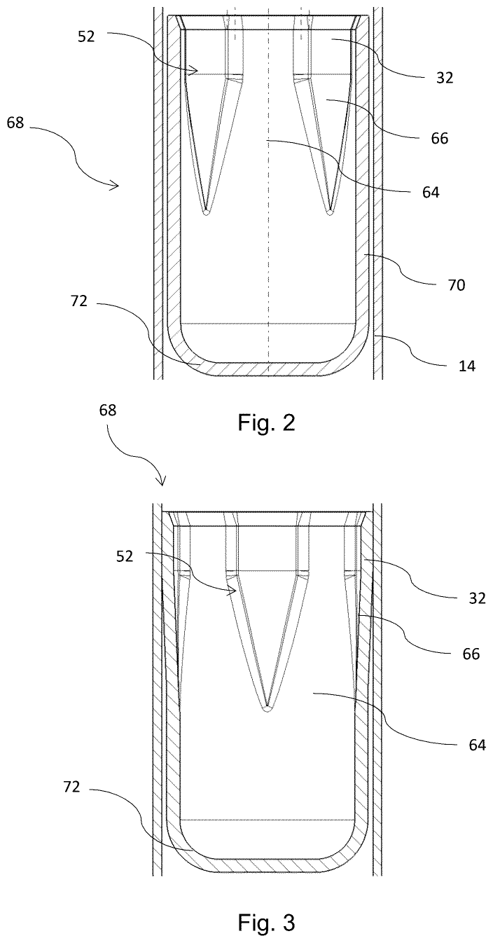

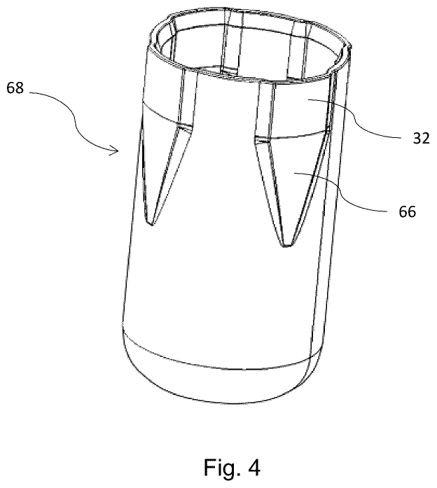

FIGS. 2 to 4 show the compression stop receptacle 68 in different sectional illustrations and in a perspective view. The compression stop receptacle 68 is cylindrical, for example, and has a wall 70. For example, the wall 70 of the compression stop receptacle 68 has no bores or passages through which hydraulic fluid is able to flow through the wall 70. The compression stop receptacle 68 preferably has a plurality of expansions 52 which are formed in the wall 70. Preferably, the compression stop receptacle 68 comprises a cylindrical region 64, which has a constant diameter. The expansions 52 are preferably enlargements in diameter of the compression stop receptacle 68 and protrude in particular in the radial direction from the cylindrical region 64.

For example, the compression stop receptacle 68 has five expansions 52. The plurality of expansions 52 are preferably spaced uniformly from one another in the circumferential direction. The expansions 52 preferably each have a first region 32, which is arranged at the piston rod end of the compression stop receptacle 68 and in particular has a constant diameter over the axial extent of the first region. Preferably, the first region 32 is designed as a fastening region, which is firmly connected to the inner wall of the damper tube 14. In particular, the compression stop receptacle 68 is connected to the damper tube 14 via the first region 32 in a material, positive or non-positive manner. The first region 32 preferably has a constant circumferential width over the axial extent.

The expansions 52 each preferably have a second region 66, which directly adjoins the first region 32 in the axial direction, in particular in the direction away from the piston rod. The second region 66 has in particular a diameter that changes over the axial extent of the second region 66. In particular, the diameter of the second region 66 decreases in the axial direction, in particular in the direction of the bottom piece 36 or in the compression direction D. Preferably, the diameter decreases constantly in the axial direction. The second region 66 preferably has a circumferential width that changes over the axial extent. Preferably, the circumferential width decreases in the axial direction, in particular in the direction of the bottom piece 36 or in the compression direction D.

The expansions 52 each extend, for example, over about half the axial extent of the compression stop receptacle 68. The expansions 52 are preferably all identical. The lower half of the compression stop receptacle 68, facing in the direction of the bottom piece 36, is preferably formed completely as a hollow cylinder with a constant diameter in the axial direction and in particular comprises the cylinder bottom. The expansions 52 preferably extend axially from the piston rod end, in particular the end face. In particular, the compression stop receptacle 68 consists of the expansions 52, the sleeve-shaped region 64 and the bottom 72.

The expansions 52 preferably form a bypass path which is formed between the wall 70 of the compression stop receptacle 68 and the auxiliary piston 50. For example, the bypass path is designed tapering in the compression direction, so that the flow cross section of the bypass path decreases in the compression direction. The inner wall of the damper tube 14 and the outer wall of the compression stop receptacle 68 are preferably spaced apart from each other. Preferably, the sleeve-shaped region 64 is spaced apart from the damper tube 14, so that hydraulic fluid is able to flow between the damper tube 14 and the sleeve-shaped region 64 of the compression stop receptacle 68.

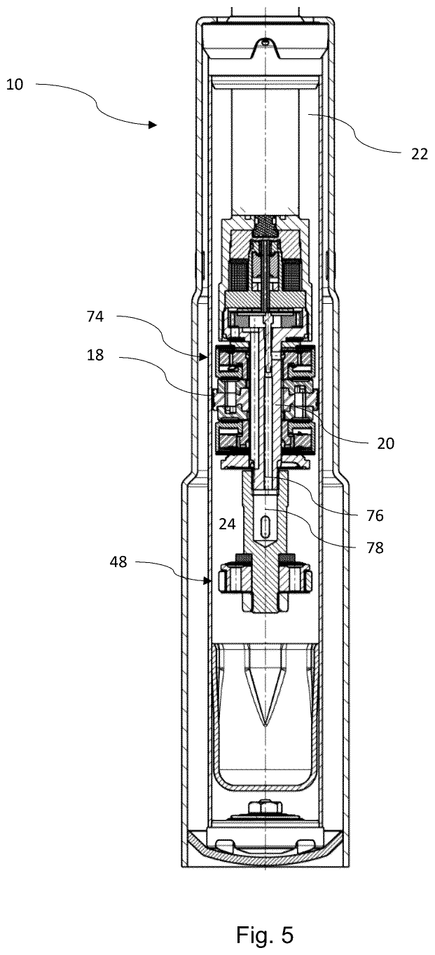

FIG. 5 shows a further exemplary embodiment of a vibration damper 10, which largely corresponds to the vibration damper of FIG. 1, with the difference that an adjusting valve 74 is mounted on the working piston 18 and can be acted on by flow via a flow channel 76 in the piston rod 20. The flow channel 76 preferably extends centrally through the piston rod 20 and is fluidically connected to the adjusting valve 74. The adjusting valve 74 is, for example, a pilot-controlled valve having a main valve and a pilot valve.

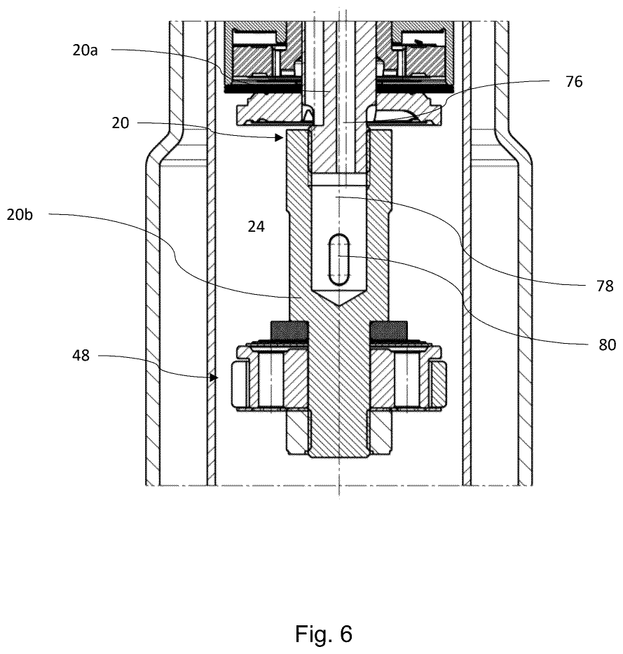

FIG. 6 shows a detailed view of the attachment of the auxiliary piston 50 to the piston rod 20. The piston rod 20 comprises, for example, a rod portion 20a, which extends centrally through the working piston, and a pin 20b, which adjoins the end of the rod portion 20a protruding into the second working chamber. The pin is designed, for example, at least partially as a hollow cylinder, so that a fluid chamber 78 is formed within the pin 20b. The pin 20b also has, for example, a fluid passage 80, which connects the fluid chamber 78 to the second working chamber 24. The fluid passage is designed, for example, as a bore with a circular diameter or as an oblong hole. Other geometries, such as a slit shape, are also conceivable. The hollow cylindrical portion of the pin 20b is preferably arranged above the auxiliary piston 50, in particular on the working piston side thereof. The fluid passage 80 and the fluid chamber 78 enable a fluid connection of the second working chamber 24 to the flow channel 76, wherein the fluid connection is also retained when the auxiliary piston is driven into the compression stop receptacle 68, and thus a flow of fluid to the adjusting valve 74 is reliably maintained.

The pin 20b is preferably screwed or clamped onto the rod portion 20a of the piston rod 20. For example, the end of the pin 20b at the rod portion side has a flat surface for supporting a tool such as a wrench.

The end of the pin 20b facing in the direction of the auxiliary piston 50 is preferably formed from a solid material and has a radial step, for example, such that the diameter decreases in the compression direction D.

### LIST OF REFERENCE SIGNS

10 Vibration damper
12 Outer tube
14 Damper tube/inner tube
16 Compensation chamber
18 Working piston
20 Piston rod
20a Rod portion
20b Pin
22 First working chamber
24 Second working chamber
30 Piston ring
32 Connecting region
34 Disc
36 Bottom piece
38 Base valve
48 Compression stop assembly
50 Auxiliary piston
52 Expansions
56 Compression stage working chamber
58 Valve body
60 Passage bores
62 Valve discs
64 Cylindrical region
66 Second region
68 Compression stop receptacle
70 Wall of the compression stop receptacle
72 Base
74 Adjusting valve
76 Flow channel
78 Fluid chamber
80 Fluid passage
Z Rebound direction
D Compression direction

1. A vibration damper for a vehicle, comprising:
a damper tube filled with hydraulic fluid;
a working piston, which is connected to a piston rod and is arranged movably back and forth within the damper tube, the interior of the damper tube being divided by the working piston into a first working chamber on the piston rod side and a second working chamber away from the piston rod;
an auxiliary piston mounted on the piston rod; and
a compression stop assembly with a compression stop receptacle mounted inside the damper tube, for receiving the auxiliary piston in the compression stage;
wherein the compression stop receptacle comprises a sleeve-shaped region with a constant diameter and has at least one expansion protruding radially from the sleeve-shaped region.

2. The vibration damper according to claim 1, wherein the expansion extends axially from the piston rod end of the compression stop receptacle.

3. The vibration damper according to claim 1, wherein the sleeve-shaped region has a constant diameter over the complete axial extent of the compression stop receptacle, with the exception of the at least one expansion.

4. The vibration damper according to claim 1, wherein the compression stop receptacle has a plurality of expansions, which are spaced uniformly apart from one another in the circumferential direction.

5. The vibration damper according to claim 1, wherein the expansion has a first region, which is arranged at the piston rod end of the compression stop receptacle and has a constant diameter over the axial extent of the first region.

6. The vibration damper according to claim 5, wherein the compression stop receptacle is mounted on the damper tube via the first region.

7. The vibration damper according to claim 5, wherein the first region has a constant circumferential width over the axial extent.

8. The vibration damper according to claim 5, wherein the expansion has a second region, which directly adjoins the first region in the axial direction and has a diameter that changes over the axial extent of the second region.

9. The vibration damper according to claim 8, wherein the diameter of the second region decreases constantly in the axial direction.

10. The vibration damper according to claim 8, wherein the second region has a circumferential width that changes over the axial extent.

11. The vibration damper according to claim 8, wherein the circumferential width of the second region decreases constantly in the compression direction.

12. The vibration damper according to claim 1, wherein the compression stop receptacle has a plurality of expansions, all of which are identical.

13. The vibration damper according to claim 1, wherein the expansion extends over about half the axial extent of the compression stop receptacle.

14. The vibration damper according to claim 1, wherein the compression stop receptacle has a wall, and wherein the expansion forms a bypass path between the wall of the compression stop receptacle and the auxiliary piston.

15. The vibration damper according to claim 1, wherein the compression stop receptacle has a wall, which has no bores or passages through which hydraulic fluid is able to flow through the wall in the radial direction.
